(19) United States
(12) Patent Application Publication
(10) Pub. No.: US 2015/0352487 A1
(43) Pub. Date: Dec. 10, 2015

(54) Method and Device for Removal of Hydrogen Sulfide from a Gas

(71) Applicant: Mark A. Moser, Oakland, CA (US)

(72) Inventor: Mark A. Moser, Oakland, CA (US)

(21) Appl. No.: 14/297,754

(22) Filed: Jun. 6, 2014

(51) Int. Cl. B01D 53/52; B01D 53/84

(52) U.S. Cl. CPC B01D 53/52; B01D 53/84; B01D 2251/95

(57) ABSTRACT

A process is provided for removing hydrogen sulfide (H₂S) from gas streams, such as natural gas, biogas, or odorous air, and converting the H₂S into sulfate and sulfur. The invention uses a countercurrent flow bio-trickling filter to capture H₂S in acidic liquid and then removes the acidic liquid to a separate tank where aeration is used to convert H₂S biologically to sulfate and sulfur.

### CROSS-REFERENCE TO RELATED APPLICATION

This patent application claims the benefit of Application No. 61832487, filed on Jun. 7, 2013 as a provisional application for the invention claimed herein.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND

This invention relates to biogas applications and to the field of abatement of toxic and noxious gases, particularly to the field of biological hydrogen sulfide (H₂S) removal systems and methods of abatement of H₂S gas. Hydrogen sulfide has a number of undesirable properties. At low concentrations, the gas has a strong odor of “rotten eggs.” At high concentrations the gas can no longer be smelled, but can induce dizziness and other undesirable health effects, including death. Hydrogen sulfide can be reduced in the environment to sulfur dioxide, a chemical that contributes to acid rain.

Biogas, a gaseous fuel produced by the biological breakdown of organic matter by bacteria in the absence of oxygen, often contains H₂S. Biogas may occur during anaerobic digestion or fermentation of biodegradable materials such as manure, biomass, sewage, municipal waste, green waste, plant material and crops. Biogas primarily comprises methane and carbon dioxide, and may contain moisture and siloxanes in addition to H₂S. Anaerobic digestion can use a multitude of feed stocks to produce methane-rich biogas including but not limited to purpose-grown crops such as maize. Landfills also produce biogas through the anaerobic digestion process. As part of an integrated waste management system, biogas is a renewable energy that may be collected and processed for beneficial use while simultaneously reducing pollution, reliance on fossil fuels, and greenhouse gas emissions into the atmosphere. Similar to natural gas, methane captured by a biogas system can be used to provide heat, electrical power, or transportation biofuel.

Biological H₂S systems have been used for the removal of H₂S from a gas. In some cases, biological H₂S removal systems can be several orders in magnitude lower in cost than expensive sulfur removal systems such as pressure swing adsorption, impregnated media or iron chelating systems. Conventional biological systems, however, can require more than 2% oxygen to maintain a stable removal rate of H₂S, and most raw gas from landfills and digesters contains far less than 2% oxygen. Accordingly, the raw gas from landfills and digesters cannot be processed using a conventional biological H₂S removal system due to scarcity of oxygen.

Oxidizing hydrogen sulfide produces acid. A central problem that must be addressed by current technologies for typical biological H₂S systems, therefore, is the high operating costs of alkaline buffering solutions used to control pH due to that acid production. In addition, nitrogen in the air added to the gas stream to oxidize hydrogen sulfide in typical biological H₂S scrubbers dilutes the combustion value or potency of the biogas. Another problem with conventional systems is the buildup of oxidizing bacteria, sulfate and sulfur inside the scrubber when oxidation occurs inside the scrubber.

### SUMMARY

The present invention was developed to address several needs. First, it was developed to address the high costs of scrubbers by reducing the need for buffering solutions and reducing or eliminating the need to buy caustic solutions that have hazardous material designations and require registered transportation, storage and handling. Second, by oxidizing sulfide in an aerated chamber away from the gas stream, the present invention reduces the dilution of biogas and retains more of the fuel potency. Third, the invention uses bacterial oxidation in an aeration chamber, reducing the buildup of bacteria, sulfate and sulfur in the scrubber media.

An embodiment of the present invention is directed toward a biological H₂S removal system for the treatment of process gas, comprising a housing that receives a process gas stream through a gas inlet, the housing comprising a media bed through which the process gas flows while it is treated for H₂S removal, and a gas outlet through which a treated gas stream exits; wherein acidic liquid including bacteria and essential nutrients (“Removal Liquid”) is sprayed onto the media bed and circulates through the system. The Removal Liquid may be heated.

In some embodiments of the invention, an air-tight scrubber system full of inert media is provided through which a gas containing hydrogen sulfide flows. Bacteria capable of adsorbing, absorbing, trapping, or reacting with the H₂S, such as those from the genus acidithiobacillus, for example, acidithiobacillus thiooxidans, acidithiobacillus ferrooxidans, acidithiobacillus albertensis, acidithiobacillus caldus, acidithiobacillus cuprithermicus, and acidithiobacillus ferrivorans, grow on the surface of the media and capture the H₂S. Bacterial growth may be limited due to a lack of oxygen in the gas stream. The Removal Liquid trickles through the media in the opposite direction from the flow of gas to absorb the hydrogen sulfide (H₂S) as the liquid flows to one end of the scrubber, where it will exit the scrubber vessel. Alternatively, the liquid may be captured elsewhere in the vessel as it flows through the media and be directed away from it. The solution containing H₂S exits the scrubber and flows to an aeration or “settling” tank. The tank is vigorously aerated to convert aqueous phase hydrogen sulfide to particulate sulfate and sulfur, and the oxidation process frees water into the circulating solution. A settler collects the particulate sulfate and sulfur. The circulating solution is maintained as an acidic liquid, preferably between pH 1 and pH 3, through the addition of nutrients and water. The circulating solution also maybe heated, and the heat may be supplied by a hot liquid, which may be a cooling liquid from a gas fueled generator or other hot liquid source. Heat may be transferred to the circulating solution through a variety of means, such as direct heating or a heat exchanger. The heat exchanger may consist substantially of PEX tubing to reduce or eliminate corrosion. Excess liquids exit the scrubber and may be mixed with settled solids to be used as fertilizer. The gas exits the scrubber with a reduced concentration of H₂S.

### BRIEF DESCRIPTION OF THE DRAWINGS

FIG. 1 is a process flow diagram showing the process of the invention.

FIG. 2 is a schematic diagram showing the flows of gas and liquid through the interior of the scrubber.

FIG. 3 is a schematic diagram showing the flow and aeration of liquid in the settling tank.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, “present invention” refers to any one of the embodiments described herein and any equivalents. Furthermore, reference to a feature or various features of the “present invention” throughout this document does not mean that all claimed embodiments or methods must include the referenced feature or features.

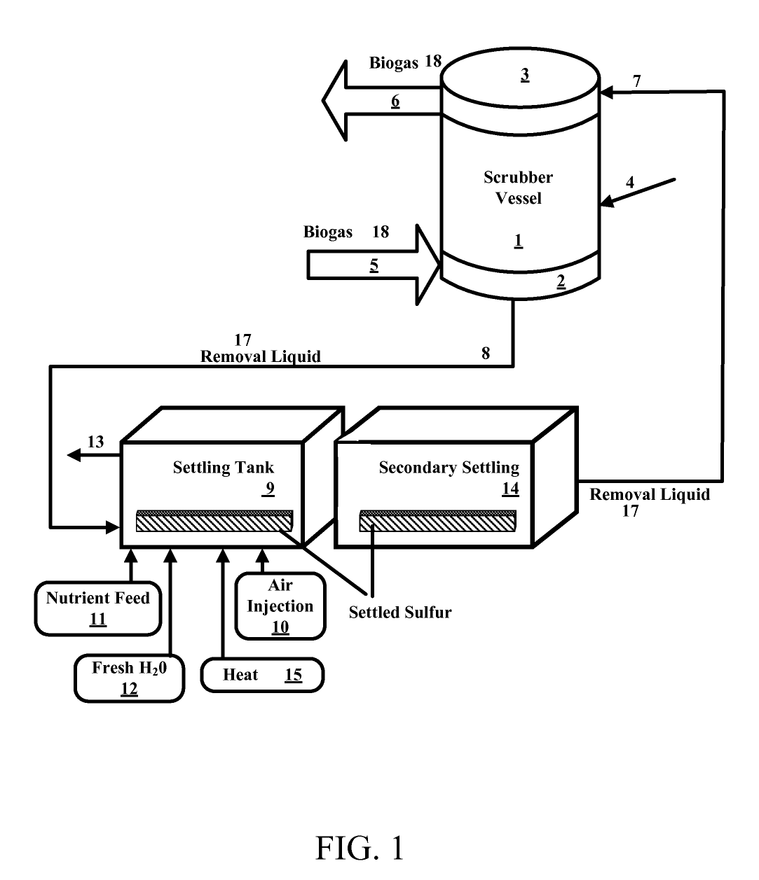

The invention includes a mostly air-tight vessel (“Scrubber Vessel”). FIG. 1 illustrates one embodiment of the invention. As shown, the Scrubber Vessel (1) includes a first end (2) and a second end (3) that opposes the first end. The Scrubber Vessel may be oriented in a manner to allow counter-flow of liquid and gas, such as vertically with the first end (2) below the second end (3). The first end is connected to and sealed against one end of a connecting side wall or connecting side walls, which may be one continuous surface (4). The second end (3) of the Scrubber Vessel is connected to and sealed against the opposing end of the connecting side wall or connecting side walls (4) forming a mostly sealed container.

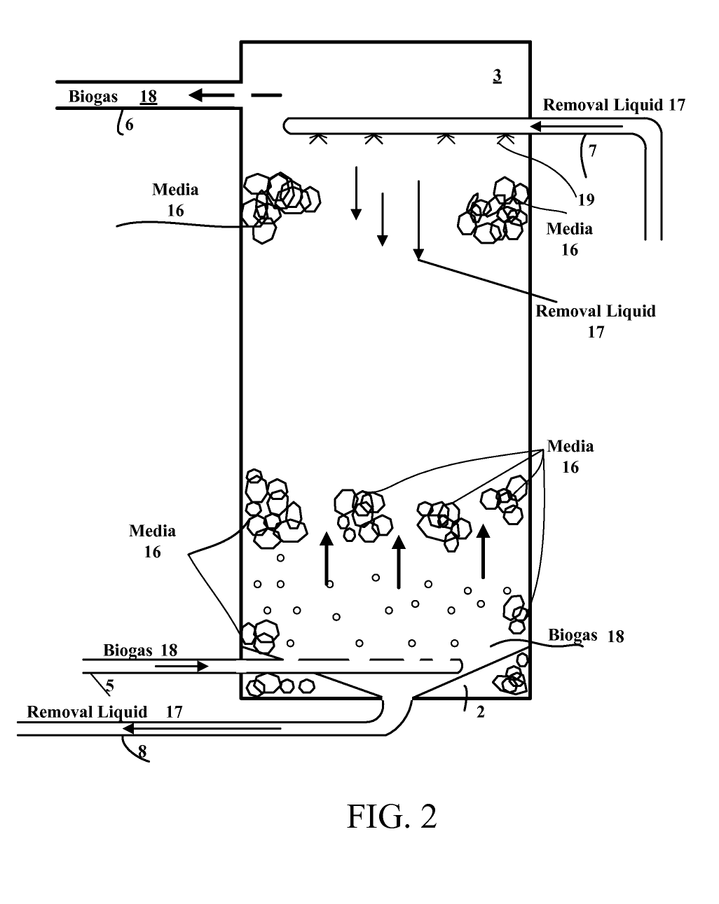

The Scrubber Vessel is filled with an inert media consisting of a plurality of solids providing surface area (“Media”). FIG. 2 illustrates one embodiment of the interior of the Scrubber Vessel. The solids of the Media (16) may be virtually any inert material, such as rocks of varying or uniform size and shape or plastic media of various shapes and surface areas such as pall rings, pvc spheres, or shaped high density polyethylene (HDPE) with penetrations that provide a surface for bacteria to grow. The solids of the Media also will be of a size that will allow liquid to flow between the individual solid particles. Bacteria, such as those from the genus acidithiobacillus, for example, acidithiobacillus thiooxidans, acidithiobacillus aferrooxidans, acidithiobacillus albertensis, acidithiobacillus caldus, acidithiobacillus cuprithermicus, and acidithiobacillus ferrivorans, grow on the surface of the solids media. The supply of oxygen to the bacteria may be limited to restrict the growth of the bacteria.

An acidic liquid (“Removal Liquid”) (17) containing bacteria and essential nutrients circulates through the system. The Removal Liquid may be a water based liquid with nutrients and micronutrients. In some embodiments, the Removal Liquid may be water combined with digester or sewage treatment effluent. Alternatively, it may be water combined with another source of nutrients, which may comprise, for example, iron, boron, copper, manganese, zinc, nickel, nitrogen, phosphorus, and/or potassium, such as Micro 500 by Agro-Culture Liquid Fertilizers, combined with a fish emulsion such as Alaska Fish Fertilizer (5-1-1 NPK). Macro and micro nutrients may be added as supplements as necessary. The proportion of water to effluent or other nutrient source is adjusted so that the Removal Liquid remains acidic, preferably in the range of pH 1 to pH 3.

Gas containing H₂S (18), such as biogas or methane, is introduced into the Scrubber Vessel. It may be introduced through one or more conduits. In the embodiment shown in FIG. 2, it is introduced through a first conduit (5) such as a pipe into the Scrubber Vessel near its first end and is allowed to flow, for example, due to density or temperature variations, through the Scrubber Vessel from its first end toward its second end (3), passing through the Media (16). The bacteria on the Media absorb, adsorb, trap or react with the H₂S in the gas as it passes along the surface of the Media, reducing the concentration of H₂S in the gas and thereby creating a “cleaned gas.” The cleaned gas exits the Scrubber Vessel through one or more additional conduits. In the embodiment shown in FIG. 2, the biogas (18) exits the Scrubber Vessel through a second conduit that is connected to and into the Scrubber Vessel near its second end (6).

The circulating Removal Liquid (17) is introduced into the Scrubber Vessel. The Liquid may be introduced through one or more conduits. In the embodiment shown in FIG. 2, it is introduced into the Scrubber Vessel through a third conduit (7) near the second end of the Scrubber Vessel (3). In some embodiments, one or more spray tip nozzle devices (19) may be placed at the end of the conduits to apply the Removal Liquid to the media. For example, one or more spray tip nozzle devices (19) may be placed at the end of the third conduit (7) near where it is connected to the second end of the Scrubber Vessel to apply the Removal Liquid onto the media after it enters the Scrubber Vessel from the third conduit (7).

After entering the Scrubber Vessel, the Removal Liquid (17) contacts the H₂S on the Media (16) as it moves through the Scrubber Vessel. In the embodiment shown in FIG. 2, it moves toward the first end (2) after being introduced into the Scrubber Vessel near the second end (3). The Removal Liquid (17) reacts with, adsorbs, or absorbs the H₂S and carries it away as the Removal Liquid flows over the bacteria covered media. The Removal Liquid carrying the H₂S is removed or allowed to exit from the Scrubber Vessel. In the embodiment shown in FIG. 2, as the Removal Liquid nears the first end of the Scrubber Vessel, it flows out of the Scrubber Vessel via a fourth conduit (8) connected to the Scrubber Vessel near the first end.

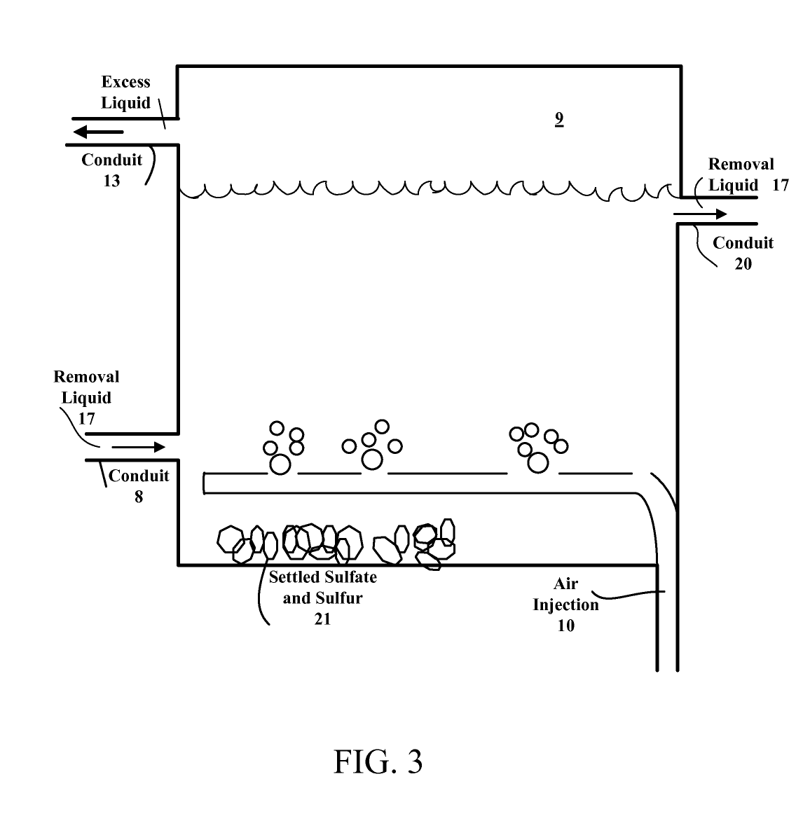

The Removal Liquid then flows to a vessel capable of containing the Removal Liquid (“Settling Tank”). In the embodiment shown in FIG. 3, it flows through the fourth conduit (8) to the Settling Tank (9). The Settling Tank may be an aeration tank or chamber. An oxygen containing gas, such as air, may be injected (10) into the Settling Tank. The oxygen reacts with the H₂S (oxidation), converting at least a part of the aqueous phase hydrogen sulfide to particulate sulfate and sulfur. The oxidation also may create water that is released into the Removal Liquid. Excess fluid may be diverted from the Settling Tank. In the embodiment shown in FIG. 3, it is diverted from the Settling Tank through a fifth conduit (13). Some of the particulate sulfate and sulfur may settle from the Removal Liquid to the bottom of the tank (21), from which it may be removed periodically or continuously by manual, hydraulic, or mechanical means. For example, in one embodiment, the Settling Tank may be periodically drained and the settled sulfate and sulfur removed with shovels or hydraulic pressure. In another embodiment, the settled particulates may be removed by a mechanical conveyor. Optionally, the Removal Liquid may be directed to a supplemental tank. In one embodiment, it may be diverted by way of a sixth conduit (20) to a supplemental tank (14) where additional settling of particulate sulfate and sulfur may occur, and from which additional excess fluid and settled sulfate and sulfur may be removed by manual, hydraulic, or mechanical means.

The Removal Liquid may be heated. In one embodiment, the Removal Liquid may be heated by hot liquid, such as cooling water from an energy generating device, which may be a gas-fueled generator. The heat may be transferred from the hot liquid to the acidic Removal Liquid through a heat exchanger, which may consist substantially of PEX tubing to prevent corrosion. The heat exchanger may be located in the Settling Tank or elsewhere along the flow path of the Removal Liquid.

Nutrients and/or fresh water may be added to the Removal Liquid as it circulates. In one embodiment, shown in FIG. 1, nutrients (11) and fresh water (12) are added to the Removal Liquid in the Settling Tank. Addition of nutrients and fresh water may be directed toward maintaining the Removal Liquid with an acidic pH, preferably with a pH of between pH 0.5 and pH 3. In one embodiment, the nutrients may be added and the pH controlled by adding effluent from an anaerobic digester, which may be the source of the biogas that is being treated. The effluent or other liquid may be alkaline, with a pH that is greater than 7, to prevent the pH of the Removal Liquid from dropping below a preferred pH standard, such as a pH of 1. In another embodiment, nutrients, heat, and/or fresh water may be added to the Removal Liquid after it leaves the Settling Tank or supplement tank through a seventh conduit, either by injection into the seventh conduit or in a separate vessel into which the Removal Liquid may flow from the seventh conduit.

The Removal Liquid may be returned to the Scrubber Vessel and reused, or other Removal Liquid may be introduced to treat additional H₂S-containing gas. In the embodiment shown in FIG. 1, the Removal Liquid is returned for reuse through the third conduit (7) to the Scrubber Vessel to treat additional H₂S-containing gas, thus starting another treatment cycle as described herein. (See, for example, Paragraph 00016.)

1: A method for removing hydrogen sulfide from a gas, comprising:
locating, in a first vessel, an inert media consisting of a plurality of solids upon which bacteria grow;
passing a gas containing hydrogen sulfide through the inert media;
passing an acidic liquid containing bacteria and nutrients (“Removal Liquid”) through the inert media;
collecting the Removal Liquid into a second vessel after it has made contact with the inert media;
injecting an oxygen containing gas into the second vessel; and
returning at least a portion of the Removal Liquid to the first vessel.

2: The method of claim 1, further comprising heating the Removal Liquid before passing it through the inert media.

3: The method of claim 2, further comprising heating the Removal Liquid with a hot liquid.

4: The method of claim 3, wherein the hot liquid is supplied by cooling water from an energy generator.

5: The method of claim 2, further comprising heating the Removal Liquid through a heat exchanger consisting substantially of PEX tubing.

6: The method of claim 1, further comprising adding nutrients to the Removal Liquid before it is returned to the first vessel.

7: The method of claim 6, wherein the nutrients are substantially supplied by liquid from an anaerobic digester.

8: The method of claim 6, wherein the nutrients are substantially supplied by chemical addition.

9: The method of claim 1, further comprising a Removal Liquid with a pH of equal to or greater than 0.5 and less than or equal to 3.

10: The method of claim 1, further comprising adding liquid from an anaerobic digester to the Removal Liquid before it is returned to the first vessel.

11: The method of claim 10, wherein the liquid from the anaerobic digester has a pH of greater than 7.

12: The method of claim 1, further comprising adding alkalinity to the Removal Liquid before it is returned to the first vessel.

13: The method of claim 12, wherein the alkalinity is substantially supplied by liquid from an anaerobic digester.

14: The method of claim 12, wherein the alkalinity is substantially supplied by chemical addition.

15: The method of claim 1, further comprising adding water to the Removal Liquid before it is returned to the first vessel.

16: The method of claim 1, further comprising collecting sulfur containing products in the second vessel.

17: The method of claim 16, further comprising removing the sulfur containing products from the second vessel.
